(19) United States
(12) Patent Application Publication
(10) Pub. No.: US 2025/0358144 A1
(43) Pub. Date: Nov. 20, 2025

(54) METHOD AND SYSTEM FOR RETRIEVING SANITARY DEVICE DATA

(71) Applicant: BLANCO GMBH + CO KG, Oberderdingen (DE)

(72) Inventor: Steven Schuss, Pfinztal (DE)

(73) Assignee: BLANCO GMBH + CO KG, Oberderdingen (DE)

(21) Appl. No.: 19/209,246

(22) Filed: May 15, 2025

(30) Foreign Application Priority Data
May 16, 2024 (DE) 10 2024 204 545.4

(51) Int. Cl. H04L 12/28

(52) U.S. Cl. CPC H04L 12/2825; H04L 2012/2841; H04L 2012/2847

(57) ABSTRACT

A method for retrieving sanitary device data using a terminal device, preferably a mobile terminal device, is provided wherein the sanitary device data is stored in a pseudonymized form on a network device, preferably in a cloud network, wherein the sanitary device data contains information about a sanitary device, comprising the steps:
the terminal device makes an initial data request;
the sanitary device makes a second data request after receipt of a notification from the terminal device of at least one intended instance of the first data request being sent;
the network device compares the first and second data request;
the network device provides the sanitary device data to the terminal device based on the comparison of the first and second data request;
the terminal device calls up the sanitary device data.

The invention relates to a method for retrieving sanitary device data using a terminal device, wherein the sanitary device data is stored in a pseudonymized form on a network device, wherein the sanitary device data comprises information about a sanitary device.

The invention further relates to a terminal device comprising a communication device for communicating with a network device and/or a sanitary device as well as a processor and memory with computer-readable instructions.

The invention further relates to a sanitary device comprising a communication device for communicating with a network device and/or a terminal device as well as a processor and memory with computer-readable instructions.

The invention further relates to a network device comprising a communication device for communicating with a sanitary device and/or a terminal device as well as a processor and memory with computer-readable instructions.

The invention further relates to a system comprising a terminal device, a sanitary device and a network device.

Although the invention is generally applicable to any sanitary device, terminal device and network device, this invention is described in relation to kitchen sinks, mobile terminal devices and a cloud network.

Modern sanitary devices such as kitchen sinks or similar can generate sanitary device data that can provide information about the use of the sanitary device. For example, sanitary device data can include the amount of hot water used, the amount of cold water used or the device's energy consumption. This sanitary device data can be stored in the cloud for easy retrieval and, if necessary, can also be used for anonymized evaluation by a manufacturer.

It is known that this involves creating a user account for a user and using the user account to access the sanitary device data in the cloud. However, the disadvantage of this method is that it is not possible to store the sanitary device data in a pseudonymized form, as the sanitary device data must always be assigned to a user account. This means that in the event of unauthorized access to the cloud, sensitive sanitary device data may be disclosed to third parties.

It is also known that the pseudonymized storage of sanitary device data in the cloud is possible. The disadvantage of this is that it is not clear who has access to the sanitary device data, as the owner of the sanitary device is unknown. It is therefore possible for an unauthorized third party to impersonate the owner of the sanitary device in order to gain access to the sanitary device data.

The goal of this invention is to provide a method for retrieving sanitary device data using a terminal device, wherein the sanitary device data is stored in pseudonymized form on a network device, wherein the sanitary device data comprises information about a sanitary device.

A further goal of this invention is to provide a corresponding terminal device, a sanitary device, a network device and a system comprising terminal device, sanitary device and network device.

Furthermore, it is a goal of this invention to provide an alternative method for retrieving sanitary device data, an alternative terminal device, an alternative sanitary device, an alternative network device and an alternative system comprising a terminal device, a sanitary device and a network device.

In one embodiment, this invention achieves the aforementioned goals with a method for retrieving sanitary device data using a terminal device, preferably a mobile terminal device, wherein the sanitary device data is stored in a pseudonymized form on a network device, preferably in a cloud, wherein the sanitary device data comprises information about a sanitary device, comprising the following steps:
The terminal device makes an initial data request;
The sanitary device makes a second data request after receiving a notification of at least one intended instance of the first data request by the terminal device;
The network device compares the first and second data request;
The network device provides the sanitary device data to the terminal device based on the comparison of the first and second data request;
The terminal device calls up the sanitary device data.

In one embodiment, this invention achieves the aforementioned goals with a terminal device, preferably a mobile terminal device, comprising a communication device for communicating with a network device, preferably a cloud network, and/or a sanitary device, as well as a processor and memory with computer-readable instructions which, when executed by the processor, cause the terminal device to:
send a command to the sanitary device, wherein the command comprises terminal device identification information,
make a first data request to the network device, wherein the first data request is generated based on the terminal device identification information, and
receive sanitary device data from the network device.

In one embodiment, this invention achieves the aforementioned goals with a sanitary device comprising a communication device for communicating with a network device, preferably a cloud network, and/or a terminal device, preferably a mobile terminal device, as well as a processor and memory with computer-readable instructions which, when executed by the processor, cause the sanitary device to:
receive a command from the terminal device, wherein the command comprises terminal device identification information, and
make a second data request to the network device, wherein the data request is generated based on the terminal device identification information and sanitary device identification information.

In one embodiment, this invention achieves the aforementioned goals with a network device, preferably a cloud network, comprising a communication device for communicating with a sanitary device and/or a terminal device, preferably a mobile terminal device, as well as a processor and memory with computer-readable instructions which, when executed by the processor, cause the network device to:
receive a first data request from the terminal device, wherein the first data request is generated based on terminal device identification information,
receive a second data request from the sanitary device, wherein the second data request is generated based on the terminal device identification information and sanitary device identification information,
compare the first and second data request, and
send sanitary device data to the terminal device based on the comparison of the first and second data request.

In one embodiment, this invention solves the aforementioned problems with a system comprising a terminal device according to claim 14, a sanitary device according to claim 15 and a network device according to claim 16.

One of the advantages of this is that unauthorized access to sanitary device data by a third party can be simply and reliably prevented. A further advantage is that it is not possible to retrieve sanitary device data without direct proximity to the sanitary device, preventing retrieval of the sanitary device data by an external user.

In one embodiment of the method, the data retrieval can be initiated by the terminal device. The terminal device can send a data request to the network device for this purpose. The sanitary device can receive a notification that the terminal device has sent or will send the data request and send a second data request itself. Preferably, the notification can be sent from the terminal device. The network device can receive both data requests and can determine from the comparison of the two data requests that the terminal device may receive the sanitary device data. It can then make the sanitary device data available to the terminal device so that the terminal device can retrieve the sanitary device data.

Further features, advantages and further embodiments of the invention are described or disclosed below.

A preferred embodiment of the invention is that the first data request comprises terminal device identification information. The terminal device identification information can be, for example, the ID of the terminal device. Terminal device identification information can be used to uniquely identify a terminal device. One advantage of this is that a terminal device that has already been authorized to receive sanitary device data can be easily recognized. This allows sanitary device data to be provided directly to the terminal device without it being necessary to re-authenticate the terminal device.

A further preferred embodiment of the invention is that the terminal device identification information is generated based on a hash, a system time and a first random value. For example, the terminal device identification information can be a hash of the system time and the random value. One advantage of this is that it prevents multiple terminal devices from having the same terminal device identification information. Another advantage of this is that it makes it more difficult for an unauthorized third party to determine the terminal device identification information by chance.

A further preferred embodiment of the invention is that the second data request comprises sanitary device identification information. One advantage of this is that the sanitary device identification information can be used to uniquely identify a sanitary device.

A further preferred embodiment of the invention is that the sanitary device identification information is generated based on a hash, the sanitary device's serial number and a second random value. One advantage of this is that it prevents multiple sanitary devices from receiving the same sanitary device identification information, as serial numbers are unique. Another advantage is that it is more difficult for an unauthorized third party to determine terminal device identification information by chance.

A further preferred embodiment of the invention is that the second data request is generated based on the terminal device identification information. The second data request can be generated based on the terminal device identification information if the sanitary device knows the terminal device identification information. This means that the sanitary device is already connected to the desired terminal device. One advantage of this is that it prevents sanitary device data from being provided to an unwanted user, as the second data request is not referencing the unwanted user's terminal device.

A further preferred embodiment of the invention is that comparing the first and second data requests consists of querying whether the terminal device identification information corresponds to the sanitary device identification information. The sanitary device identification information may, for example, include the terminal device identification information. This allows the network device to check whether the terminal device identification information contained in the sanitary device identification information actually corresponds to the terminal device identification information provided in the first data request. The sanitary device data is only provided to the terminal device if the terminal device identification information and the sanitary device identification information correspond to each other. In this way, it is possible to ensure that only the terminal device of the desired user receives the sanitary device data and not a terminal device of an unauthorized user.

In a further preferred embodiment of the invention, comparing the first and second data requests consists of comparing the times at which the first and second data requests were made and whether the difference between the two times is less than a threshold value. Preferably, it is possible to check whether the two data requests were made within a defined time interval. For example, it is possible to check whether the data requests were made within a period of less than 5 minutes, less than 3 minutes, less than 1 minute or less than 10 seconds. One advantage of this is that it reduces the likelihood of an unauthorized user gaining access to the sanitary device data.

In a further preferred embodiment of the invention, the second data request is only made when a user actuates an actuating element on the sanitary device. For example, a user could send the first data request using the terminal device and then press an actuator on the sanitary device, causing the sanitary device to send the second data request. One advantage of this is that it ensures that the data was retrieved by an authorized user.

In a further preferred embodiment of the invention, the second data request is only made when the terminal device sends a command to the sanitary device via a wireless communication device, preferably via Bluetooth. For example, the terminal device can be connected to the sanitary device via Bluetooth and send a notification to the sanitary device via the Bluetooth connection. The notification may include a command to make the second data request and/or communicate the terminal device identification information. This means that the terminal device must be in physical proximity to the sanitary device in order to trigger a data request. One advantage of this is that unauthorized users not in physical proximity to the sanitary device are prevented from gaining access to the sanitary device data.

In a further preferred embodiment of the invention, the wireless communication device requires connection information to communicate with the sanitary device, wherein the connection information is physically present on the sanitary device. For example, the information required for the connection could take the form of a password printed on the sanitary device. The terminal device is only able to communicate with the sanitary device if the user enters the connection information into the terminal device. This means that a user must be in physical proximity to the sanitary device in order to acquire the connection information. One advantage of this is that unauthorized users not in physical proximity to the sanitary device are prevented from gaining access to the sanitary device data.

In a further preferred embodiment of the invention, the second data request is only sent if the strength of the signal of the command from the wireless communication device is greater than a threshold value when the command is received by the sanitary device. In other words, the sanitary device will only send the second data request if the signal strength of the communication between the sanitary device and the terminal device is sufficiently high. In this way, the second data request can only be made when the terminal device is in physical proximity to the sanitary device. One advantage of this is that it can prevent an unauthorized user from gaining access to the sanitary device data in a larger area around the sanitary device.

In a further preferred embodiment of this invention, the network device stores the sanitary device identification information and/or the terminal device identification information. Once sanitary device data is provided to the terminal device, the terminal device can be classified as an authorized terminal device. This means that sanitary device data can be provided directly to the terminal device upon subsequent data requests. For this purpose, the sanitary device identification information and/or the terminal device identification information can be stored on the network device so that the terminal device can be identified. One advantage of this is that subsequent data requests are simplified by the terminal device.

Further important features and advantages of the invention can be seen in the sub-claims, the drawings and the related illustration captions with reference to the drawings.

It is understood that the features mentioned above and those to be explained below can be used not only in the combination indicated in each case, but also in other combinations or on their own, without departing from the scope of this invention.

Preferred designs and embodiments of this invention are shown in the drawings and are explained in more detail in the following; wherein identical references are referred to identical or similar or functionally identical components or elements.

As such,

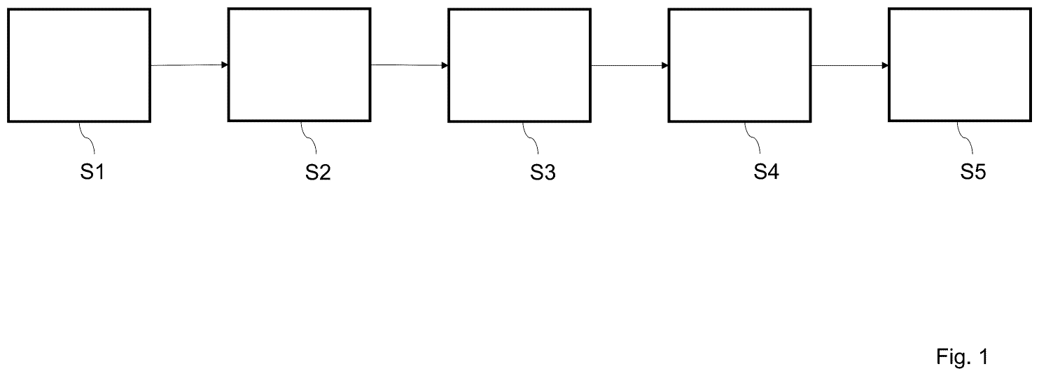

FIG. 1 shows the steps of one process in one embodiment of this invention;

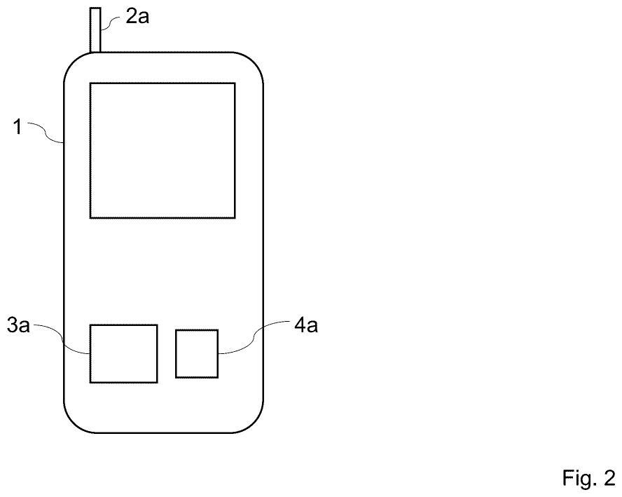

FIG. 2 shows a terminal device in one embodiment of this invention;

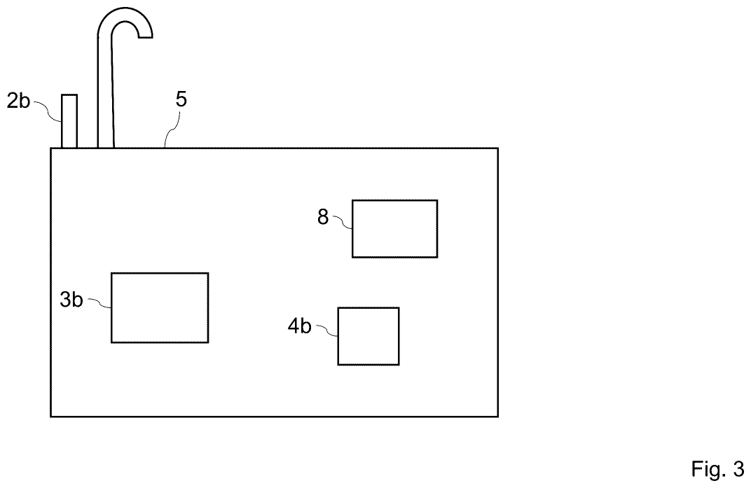

FIG. 3 shows a sanitary device in one embodiment of this invention;

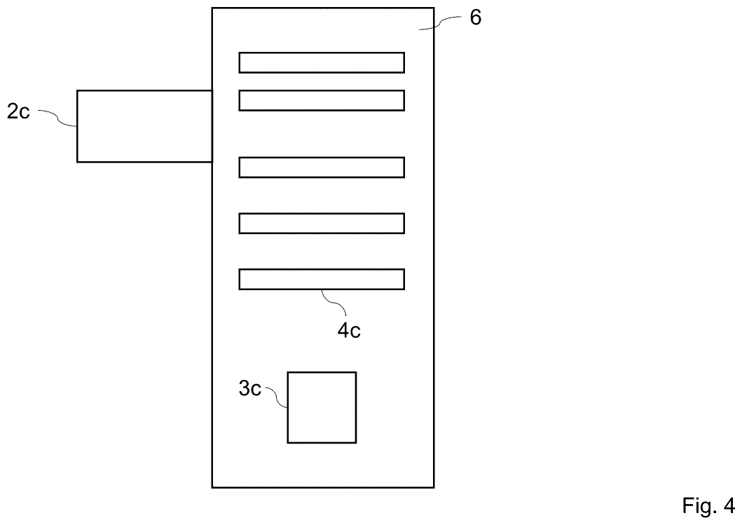

FIG. 4 shows a network device in one embodiment of this invention; and

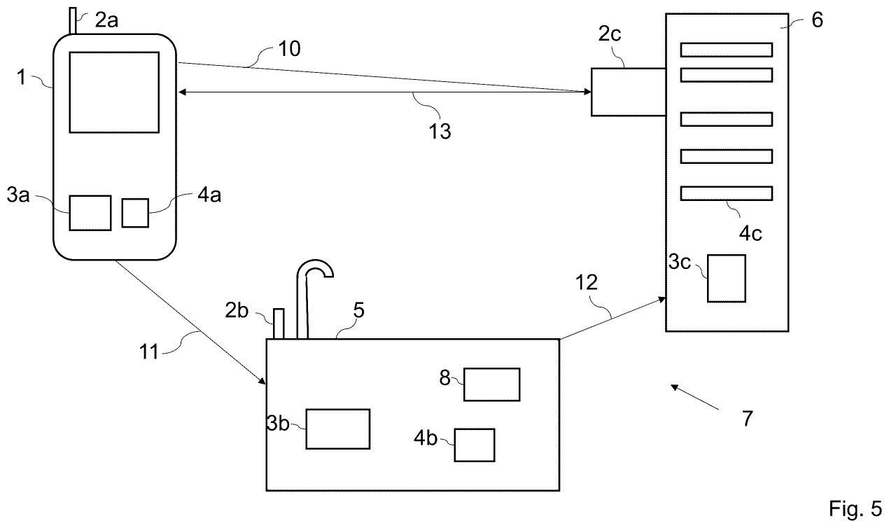

FIG. 5 shows a system in one embodiment of this invention.

FIG. 1 shows schematics of the steps of a method in one embodiment of this invention.

FIG. 1 shows steps of a method for retrieving sanitary device data using a terminal device. Preferably, the terminal device can be a mobile device such as a smartphone, tablet or laptop. The sanitary device data includes information about the sanitary device, such as the amount of water used, average water temperature, energy consumption, maintenance cycles and/or CO₂ cartridge fill level. The sanitary device data is stored on a network device, wherein the network device can be a local server or a cloud network, for example. Preferably, the sanitary device data is stored in a pseudonymized form on the network device so that an unauthorized third party cannot match the sanitary device data to a specific sanitary device.

In step S1, a first data request is made by the terminal device. The data request can, for example, include terminal device identification information, preferably an ID of the terminal device. The ID is formed from a hash of a random number and the system time in order to generate a unique ID that cannot be randomly determined by an unauthorized user. The first data request is sent to the cloud. At this point, however, the cloud will not yet provide the sanitary device data because the terminal device has not yet been authenticated.

In the second step S2, a second data request is made by the sanitary device after receiving a notification of at least one intended instance of the first data request from the terminal device. The notification includes the fact that the intention of the terminal device to make a data request, or that this request has already been made. After the terminal device has made the first data request, the terminal device sends its own ID to the sanitary device. After this message, the sanitary device sends the second data request to the cloud. It is also possible that the terminal device could first transmit its ID together with the notification to the sanitary device, the sanitary device sends the second data request and then the terminal device sends the first data request. It is also possible that the terminal device could transmit its ID together with the notification to the sanitary device and then the sanitary device and the terminal device send the data requests simultaneously. For example, the second data request may include sanitary device identification information, which may include a hash of a sanitary device serial number and a random number. Preferably, the second data request can include the ID of the terminal device.

It is possible that the sanitary device could send a confirmation to the terminal device when it receives notification of an intention to make the first data request. Preferably, this allows both devices to define a time at which they will make the data requests.

The random number reduces the probability that an unauthorized user could randomly guess a terminal device ID or sanitary device identification information.

The notification to the sanitary device can be sent from the terminal device via Bluetooth, for example. This ensures that the terminal device has already connected to the sanitary device before the data is retrieved and that the terminal device is in physical proximity to the sanitary device.

In the third step S3, the network device compares the first and second data requests. For example, the system checks whether the second data request includes the ID of the terminal device and whether the same terminal device ID is contained in the first data request. Preferably, it checks whether the first and second data requests were both made within a certain period of time. If the second data request corresponds to the first data request and both data requests were essentially made at the same time, the terminal device is authorized to receive the sanitary device data. It is possible that steps S1, S2 and S3 could be repeated at least twice or at least three times in order to exclude the possibility of an unauthorized user gaining access to the sanitary device data.

In the fourth step S4, sanitary device data is provided to the terminal device by the cloud network based on the comparison of the first and second data requests. If the terminal device has been authorized to receive the sanitary device data through the comparison of the data requests, the sanitary device data is provided to the terminal device. The sanitary device data can be stored in a pseudonymized form in the cloud and only referenced using the serial number of the sanitary device or the sanitary device identification information. As the sanitary device identification information, which may include the serial number, is transmitted during the second data request, the corresponding sanitary device data can be provided.

In the fifth step S5, the sanitary device data is received by the terminal device. It is possible that the ID of the terminal device and the sanitary device identification information could be stored in the cloud. If the terminal device makes another data request, the ID of the terminal device can be compared with the stored ID of the terminal device. If the two IDs match, further sanitary device data could be provided directly to the terminal device.

FIG. 2 shows schematics of a terminal device in one embodiment of this invention.

The terminal device 1, here in the form of a mobile terminal device 1, comprises a communication device 2a for communicating with a network device (not shown), preferably a cloud network, and/or a sanitary device (not shown) as well as a processor 3a and memory 4a with computer-readable instructions which, when executed by the processor 3a, cause the terminal device 1 to:
send a command to the sanitary device, wherein the command comprises terminal device identification information,
send a first data request to the network device, wherein the first data request is generated based on the terminal device identification information and a random value, and
receive sanitary device data from the network device.

Preferably, the terminal device 1 is designed to perform steps S1 and S5 of FIG. 1. It is possible that the terminal device 1 could send a command to the network device to delete the terminal device identification information and/or the sanitary device identification information.

A program, preferably an app, can be stored in the memory 4a, which enables a graphical display of the sanitary device data and enables the data retrieval process to be initiated.

FIG. 3 shows schematics of a sanitary device in one embodiment of this invention.

FIG. 3 shows a sanitary device 5 comprising a communication device 2b for communicating with a network device (not shown), preferably a cloud network, and/or a terminal device (not shown), preferably a mobile terminal device, as well as a processor 3b and memory 4b with computer-readable instructions which, when executed by the processor 3b, cause the sanitary device 5 to:
receive a command from the terminal device, wherein the command comprises terminal device identification information; and
make a second data request to the network device, wherein the data request is generated based on the terminal device identification information and sanitary device identification information.

Preferably, the sanitary device 5 can perform step S2 as shown in FIG. 1. The sanitary device 5 can only make the second data request to the network device if the command from the terminal device 1 specifies that the sanitary device 5 should make this data request.

The connection information 8, in this case in the form of a printed password, is provided on the sanitary device 5. Using the password 8, a user can connect a terminal device 1 to the sanitary device 5, allowing the sanitary device 5 and the terminal device 1 can communicate with each other. Preferably, this may be a Bluetooth connection. It is possible that a command to send the second data request could only be sent via this connection, preferably this Bluetooth connection. This reduces the probability that an unauthorized user could give the command to make the second data request, since the connection information 8 is only visible when a user is in front of the sanitary device 5. Even if the connection information 8 is made accessible to an unauthorized user, the unauthorized user cannot issue the command for the second data request to be sent from a location away from the sanitary device, as the connection via Bluetooth is only possible over short distances.

The sanitary device 5 can be designed to issue the command to make the second data request only if the strength of the Bluetooth connection signal is greater than a limit value. This means that only a user in the immediate vicinity of the sanitary device 5 can give the command to send the second data request.

FIG. 4 shows schematics of a network device in one embodiment of this invention.

FIG. 4 shows a network device 6, here in the form of a cloud network, comprising a communication device 2c for communicating with a sanitary device (not shown) and/or a terminal device (not shown), preferably a mobile terminal device, as well as a processor 3c and memory 4c with computer-readable instructions which, when executed by the processor, cause the network device 6 to:
receive a first data request from the terminal device 1, wherein the first data request is generated based on terminal device identification information,
receive a second data request from the sanitary device 5, wherein the second data request is generated based on the terminal device identification information and sanitary device identification information,
compare the first and second data request, and
provide sanitary device data to the terminal device 1 based on the comparison of the first and second data request.

Preferably, the network device 6 is designed to perform steps S3 and S4 as shown in FIG. 1.

The network device 6 can store the sanitary device data in a pseudonymized form and only use the serial number and/or the sanitary device identification information as a reference. This means that the sanitary device data cannot be associated with a specific user. It is possible that the network device 6 regularly could request current sanitary device data from the sanitary device 5 and/or receives current sanitary device data from the sanitary device 5 and store it.

FIG. 5 shows schematics of a system in one embodiment of this invention.

FIG. 5 shows a system 7 comprising a terminal device 2, a sanitary device 5 and a network device 6. The terminal device 2 is designed preferably in accordance with the terminal device 2 according to FIG. 2; the sanitary device 5 is designed preferably in accordance with the sanitary device 5 according to FIG. 3 and the network device 6 is designed preferably in accordance with the network device 6 according to FIG. 4.

Preferably, the system 7 is designed to perform steps S1 to S5 as shown in FIG. 1.

The terminal device 1 can send a first data request 10, comprising terminal device identification information, to the network device 6. Furthermore, the terminal device 1 can send a notification 11, here in the form of a command 11, to the sanitary device 5 to instruct it to send a second data request 12 to the network device 6. Command 11 an can include the terminal device identification information. The sanitary device 5 may send the second data request 12 to the network device 6, wherein the second data request may include the terminal device identification information and the sanitary device identification information. The network device 6 can then compare the first data request 10 and the second data request 12 and, depending on the result of the comparison, send sanitary device data 13 to the terminal device 1.

In summary, at least one embodiment of this invention may have at least one of the following features and/or provide at least one of the following advantages:
Provision of sanitary device data only to authorized users.
Protection against access to sanitary device data by external users.
Use of the terminal device as an additional authentication medium.

Although this invention has been described with reference to preferred embodiments, it is not limited thereto, but can be modified in a variety of ways.

### REFERENCE LIST

1 Terminal device
2a Communication device—Terminal device
2b Communication device—Sanitary device
2c Communication device—Network device
3a Processor—Terminal device
3b Processor—Sanitary device
3c Processor—Network device
4a Memory—Terminal device
4b Memory—Sanitary device
4c Memory—Network device
5 Sanitary device
6 Network device
7 System
8 Connection information
10 First data request
11 Notification
12 Second data request
13 Sanitary device data
S1-S5 Steps of the procedure

1. A method for retrieving sanitary device data using a terminal device, preferably a mobile terminal device, wherein the sanitary device data is stored in pseudonymized form on a network device, preferably in a cloud network, wherein the sanitary device data contains information about a sanitary device, comprising the steps:
the terminal device sends a first data request;
the sanitary device (5) sends a second data request after receipt of a notification of at least one intended instance of the first data request being sent by the terminal device;
comparison of the first and second data request by the network device;
the network device provides sanitary device data to the terminal device based on the result of the comparison of the first and second data request;
retrieval of the sanitary device data by the terminal device.

2. The method according to claim 1, characterized in that the first data request comprises terminal device identification information.

3. The method according to claim 2, characterized in that the terminal device identification information is generated based on a hash, the system time and a first random value.

4. The method according to claim 2, characterized in that the second data request comprises sanitary device identification information.

5. The method according to claim 4, characterized in that the sanitary device identification information is generated based on a hash, the serial number of the sanitary device and a second random value.

6. The method according to claim 4, characterized in that the second data request is generated based on the terminal device identification information.

7. The method according to claim 4, characterized in that the comparison of the first and second data request comprises querying whether the terminal device identification information corresponds to the sanitary device identification information.

8. The method according to claim 1, characterized in that the comparison of the first and second data request comprises comparing the times at which the first and second data request were made and whether the difference between the two times is less than a threshold value.

9. The method according to claim 1, characterized in that the second data request is only made when a user actuates an actuating element on the sanitary device.

10. The method according to claim 1, characterized in that the second data request is only made when the terminal device sends a command to the sanitary device via a wireless communication device, preferably via Bluetooth.

11. The method according to claim 10, characterized in that the wireless communication device requires connection information to communicate with the sanitary device, wherein the connection information is physically provided on the sanitary device.

12. The method according to claim 10, characterized in that the second data request is made only if the signal strength of the command from the wireless communication device is greater than a threshold value when the command is received by the sanitary device.

13. The method according to claim 2, characterized in that the network device stores the sanitary device identification information and/or the terminal device identification information.

14. (canceled)

15. A sanitary device comprising a communication device for communicating with a network device, preferably a cloud network, and/or a terminal device, preferably a mobile terminal device, as well as a processor and memory with computer-readable instructions which, when executed by the processor, cause the sanitary device to:
receive a command from the terminal device, wherein the command comprises terminal device identification information, and
make a second data request to the network device, wherein the data request is based on the terminal device identification information and sanitary device identification information.

16. (canceled)

17. A system comprising:
(a) a terminal device comprising a communication device for communicating with a network device, preferably a cloud network, and/or a sanitary device, as well as a processor and memory with computer-readable instructions which, when executed by the processor, cause the terminal device to:
send a command to the sanitary device, wherein the command comprises terminal device identification information,
make a first data request to the network device, wherein the first data request is generated based on the terminal device identification information, and
receive sanitary device data from the network device;
(b) a sanitary device comprising a communication device for communicating with a network device, preferably a cloud network, and/or a terminal device, preferably a mobile terminal device, as well as a processor and memory with computer-readable instructions which, when executed by the processor, cause the sanitary device to:
receive a command from the terminal device, wherein the command comprises terminal device identification information, and
make a second data request to the network device, wherein the data request is based on the terminal device identification information and sanitary device identification information; and
(c) a network device comprising a communication device for communicating with a sanitary device and/or a terminal device, preferably a mobile terminal device, as well as a processor and memory with computer-readable instructions which, when executed by the processor, cause the network device to:
receive a first data request from the terminal device, wherein the first data request is based on terminal device identification information,
receive a second data request from the sanitary device, wherein the second data request is based on the terminal device identification information and sanitary device identification information,
compare the first and the second data request, and
provide sanitary device data to the terminal device based on the result of the comparison of the first and second data request.
